(19) United States
(12) Patent Application Publication
(10) Pub. No.: US 2019/0331965 A1
(43) Pub. Date: Oct. 31, 2019

(54) LIGHT SOURCE MODULE, BACKLIGHT MODULE, AND LCD DEVICE

(71) Applicant: WUHAN CHINA STAR OPTOELECTRONICS TECHNOLOGY CO., LTD., Wuhan, HB (CN)

(72) Inventor: Shiyuan Xiao, Wuhan (CN)

(21) Appl. No.: 16/098,440

(22) PCT Filed: Sep. 22, 2018
(86) PCT No.: PCT/CN2018/107140

§ 371 Date: Nov. 2, 2018

(30) Foreign Application Priority Data
Apr. 26, 2018 (CN) 201810386919.7

(51) Int. Cl. G02F 1/1335

(52) U.S. Cl. CPC G02F 1/133603; G02F 1/133605

(57) ABSTRACT

The present invention teaches a light source module including a substrate, and a number of first and second LEDs disposed on the substrate. The first and second LEDs provide light of different viewing angles. A backlight module using the light source module may switch between two modes of lighting, one of a wider viewing angle and the other one of a narrower viewing angle. A LCD device using the backlight module therefore may provide different brightness to different viewing angles. Such a LCD device may differentiate itself among similar products, and achieve enhanced competitiveness in the market.

### FIELD OF THE INVENTION

The present invention is generally related to the field of display technology, and more particularly to a light source module, a backlight module, and a liquid crystal display (LCD) device.

### BACKGROUND OF THE INVENTION

Liquid crystal display (LCD) is the mainstream display device and, due to its high quality, power efficiency, thin dimension, and high applicability, is widely applied to consumer appliances such as mobile phones, televisions, personal digital assistants, digital camera, notebook computers, desktop calculators, etc.

Most LCD devices are back-lighted LCD devices which include a LCD panel and a backlight module. The working principle of a LCD panel is placing liquid crystal molecules between two parallel glass substrates, and applying electricity through many vertical and horizontal wires on the substrates to alter the angles of the liquid crystal molecules, thereby refracting the light from the backlight module.

As the LCD panel itself does not self-illuminate, to display images on the LCD panel requires the light provided by the backlight module. Therefore, the backlight module is a key component to the LCD device. There are two types of backlight modules, depending on how light is incident into the LCD panel. The direct-lit backlight module has the light source, such as cold cathode fluorescent lamp (CCFL) tubes or light emitting diodes (LEDs) disposed behind the LCD panel. The light from the light source is scattered and uniformed by a diffusion sheet and becomes a planar light for the LCD panel. The backlight module includes, in addition, a light guide plate, a brightness enhancement film, a back plate, etc. As shown in FIGS. 1 and 2, there are a number of LEDs 200 on the substrate 100. Each LED 200 includes a reflection cup 220 and a lighting chip 260. Light from the lighting chip 260 is reflected by the reflection cup 220 towards a direction away from the substrate 100. The maximum exit angle of the light from the lighting chip 260 reflected by the reflection cup 220 is the viewing angle of the LED 200. The reflection cup 220 includes an indentation 400. A bottom side of the indentation 400 has an included angle α relative to a surrounding wall. The viewing angle of the LED 200 is determined by the included angle α. Currently, all reflection cups of a conventional backlight module have an identical included angle α. When such a light source is applied to a LCD device's backlight module, the LCD device provides a single viewing angle of a same brightness. This is a constraint to the conventional LCD devices.

### SUMMARY OF THE INVENTION

An objective of the present invention is to teach a light source module capable of switching between two modes of lighting, one of a wider viewing angle and the other one of a narrower viewing angle. A LCD device using the light source module therefore may provide different brightness to different viewing angles. Such a LCD device may differentiate itself among similar products, and achieve enhanced competitiveness in the market.

Another objective of the present invention is to teach a backlight module so that a LCD device using the backlight module may provide different brightness to different viewing angles. Such a LCD device may differentiate itself among similar products, and achieve enhanced competitiveness in the market.

Yet another objective of the present invention is to teach a LCD device using a backlight module providing different brightness to different viewing angles, and therefore may differentiate itself among similar products, and achieve enhanced competitiveness in the market.

To achieve the objectives, the present invention teaches a light source module, comprising a substrate, a plurality of first light emitting diodes (LEDs) disposed on the substrate, and a plurality of second LEDs disposed on the substrate, wherein the first and second LEDs provide light of different viewing angles.

Each first LED comprises a first reflection cup on the substrate, a first lighting chip in a first indentation of the first reflection cup, and a first phosphor filling the first indentation and covering the first lighting chip, where the first indentation is provided on a side of the first reflection cup away from the substrate.

Each second LED comprises a second reflection cup on the substrate, a second lighting chip in a second indentation on the second reflection cup, and a second phosphor filling the second indentation and covering the second lighting chip, where the second indentation is provided on a side of the second reflection cup away from the substrate; wherein the first and second indentations are of different shapes.

The first indentation has a bottom side and a slant side wall surrounding the bottom side forming a first included angle relative to the bottom side; the first lighting chip is disposed on the bottom side of the first indentation.

The second indentation has a bottom side and a slant side wall surrounding the bottom side forming a second included angle relative to the bottom side; the second lighting chip is disposed on the bottom side of the second indentation.

The first and second included angles are different.

The first and second included angles are greater than 90 degrees.

The first and second lighting chips are LED lighting chips; and the LED chips are blue-light or white-light LED chips.

The first and second lighting chips are of a same color or of different colors.

The first and second LEDs are arranged into rows at uniform intervals on the substrate; and the first and second LEDs along each row are arranged alternately at uniform intervals.

The first and second LEDs are disposed to a same side of the substrate.

The present invention also teaches a backlight module, comprising a light source module as described above.

The present invention also teaches a LCD device, including a backlight module as described above.

The advantages of the present invention are as follows. The light source module taught by the present invention includes a substrate, and a number of first and second LEDs disposed on the substrate. The first and second LEDs provide light of different viewing angles. The light source module may switch between two modes of lighting, one of a wider viewing angle and the other one of a narrower viewing angle. A LCD device using the light source module therefore may provide different brightness to different viewing angles. Such a LCD device may differentiate itself among similar products, and achieve enhanced competitiveness in the market. The backlight module taught by the present invention includes the above described light source module. A LCD device using the backlight module therefore may provide different brightness to different viewing angles. Such a LCD device may differentiate itself among similar products, and achieve enhanced competitiveness in the market. The LCD device taught by the present invention includes the above described backlight module. The LCD device may differentiate itself among similar products, and achieve enhanced competitiveness in the market.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural schematic diagram showing a conventional light source module.

FIG. 2 is a structural schematic diagram showing a LED of the conventional light source module of FIG. 1.

FIG. 3 is a structural schematic diagram showing a light source module according to an embodiment of the present invention.

FIG. 4 is a structural schematic diagram showing a first LED of the light source module of FIG. 3.

FIG. 5 is a structural schematic diagram showing a second LED of the light source module of FIG. 3.

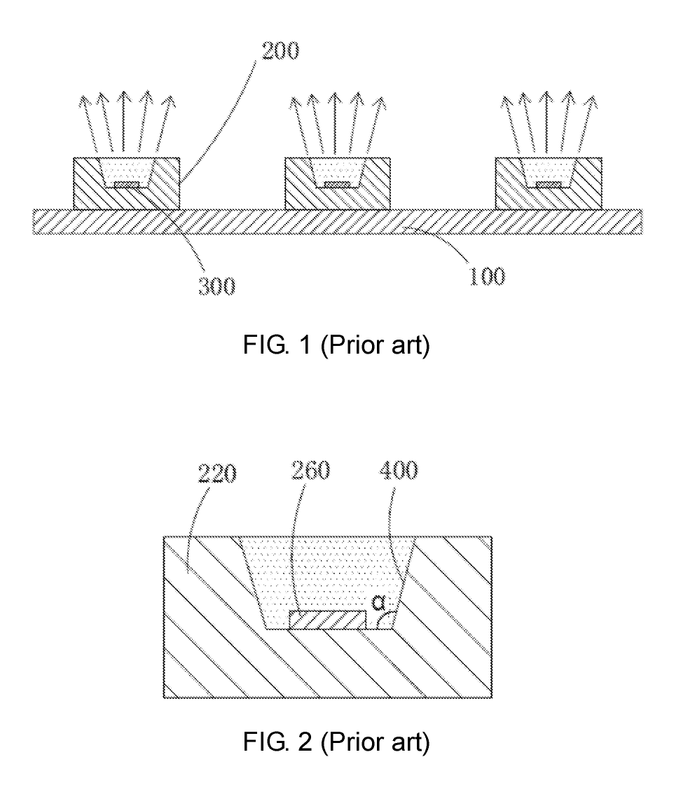

### DETAILED DESCRIPTION OF PREFERRED EMBODIMENTS

The following descriptions for the respective embodiments are specific embodiments capable of being implemented for illustrations of the present invention with referring to appended figures.

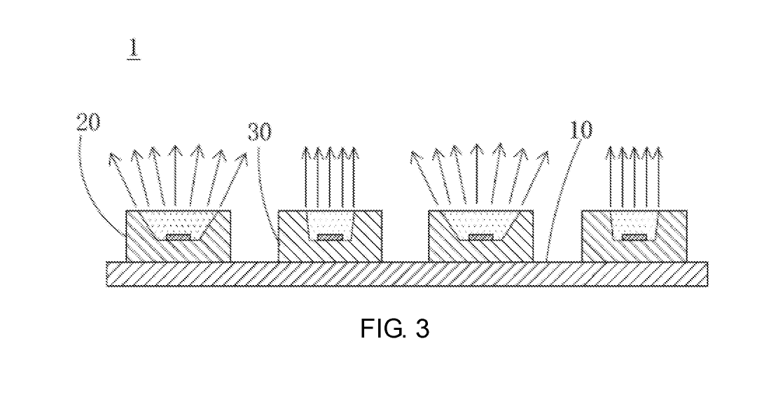

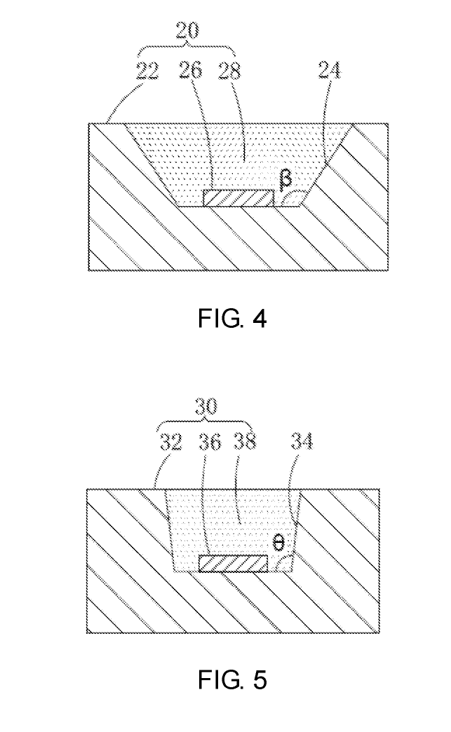

As shown in FIGS. 3 to 5, a light source module 1 according to an embodiment of the present invention includes a substrate 10, and a number of first and second light emitting diodes (LEDs) 20 and 30 disposed on the substrate 10. The first and second LEDs 20 and 30 provide light of different viewing angles. As such, the light source module 1 is able to switch two modes of lighting of different viewing angles.

Specifically, each first LED 20 includes a first reflection cup 22 on the substrate 10, a first lighting chip 26 on the first reflection cup 22, and a first phosphor 28 on the first reflection cup 22 covering the first lighting chip 26. The first reflection cup 22 reflects and achieve better utilization to light emitted from the first lighting chip 22. The first reflection cup 22 defines the viewing angle of the first LED 20.

Each second LED 30 includes a second reflection cup 32 on the substrate 10, a second lighting chip 36 on the second reflection cup 32, and a second phosphor 38 on the second reflection cup 32 covering the second lighting chip 36. The second reflection cup 32 reflects and achieve better utilization to light emitted from the second lighting chip 32. The second reflection cup 32 defines the viewing angle of the second LED 30.

Specifically, the first reflection cup 22 has a first indentation 24 with a bottom side and a slant side wall surrounding the bottom side. The bottom side and the slant side wall has a first included angle β. The first lighting chip 26 is disposed on the bottom side of the first indentation 24 and the first phosphor 28 fills the first indentation 24.

The second reflection cup 32 has a second indentation 34 with a bottom side and a slant side wall surrounding the bottom side. The bottom side and the slant side wall has a second included angle θ. The second lighting chip 36 is disposed on the bottom side of the second indentation 34 and the second phosphor 38 fills the second indentation 34.

The first and second indentations are of different shapes. The first and second included angles β and θ are different, and they respectively determine the viewing angles of the first and second LEDs 20 and 30.

Preferably, the first phosphor 28 has a top side level with a top side of the first indentation 24, and the second phosphor 38 has a top side level with a top side of the second indentation 34.

Specifically, the first and second included angles β and θ are both greater than 90 degrees so that light from the first and second LEDs 20 and 30 are projected outward.

Specifically, the first and second lighting chips 26 and 36 are LED chips. The LED chips may be blue-light or white-light LED chips. Selectively, the first and second lighting chips 26 and 36 may of a same color or of different colors.

Specifically, the first and second LEDs 20 and 30 are arranged into rows at uniform intervals on the substrate 10. The first and second LEDs 20 and 30 along each row are arranged alternately at uniform intervals. The light source module 1 as such may provide a uniform illumination.

Specifically, the first and second LEDs 20 and 30 are disposed on a same side of the substrate 10.

The light source module 1, by disposing LEDs of different viewing angles on the substrate 10, may switch between two modes of lighting, one of a wider viewing angle and the other one of a narrower viewing angle. By applying the light source module 1 to a backlight module, a liquid crystal display (LCD) device using the backlight module may provide different brightness to different viewing angles. Such a LCD device may differentiate itself among similar products, and achieve enhanced competitiveness in the market.

Based on the light source module 1, the present invention also teaches a backlight module including the above described light source module 1. For brevity's sake, the details about the light source module l′s structure are omitted here.

Preferably, the backlight module is a direct-lit backlight module.

The backlight module, by disposing LEDs of different viewing angles on the substrate 10, may switch between two modes of lighting, one of a wider viewing angle and the other one of a narrower viewing angle. By applying the backlight module to a LCD device, the LCD device may provide different brightness to different viewing angles. Such a LCD device may differentiate itself among similar products, and achieve enhanced competitiveness in the market.

Based on the above backlight module, the present invention also teaches a LCD device including the above described backlight module or light source module 1. For brevity's sake, the details about the structures of the backlight module and the light source module 1 are omitted here.

The backlight module of the LCD device includes the above described light source module 1. The light source module 1, by disposing LEDs of different viewing angles on the substrate 10, may switch between two modes of lighting, one of a wider viewing angle and the other one of a narrower viewing angle. The LCD device therefore may provide different brightness to different viewing angles. Such a LCD device may differentiate itself among similar products, and achieve enhanced competitiveness in the market.

As described above, the light source module taught by the present invention includes a substrate, and a number of first and second LEDs disposed on the substrate. The first and second LEDs provide light of different viewing angles. The light source module may switch between two modes of lighting, one of a wider viewing angle and the other one of a narrower viewing angle. A LCD device using the light source module therefore may provide different brightness to different viewing angles. Such a LCD device may differentiate itself among similar products, and achieve enhanced competitiveness in the market. The backlight module taught by the present invention includes the above described light source module. A LCD device using the backlight module therefore may provide different brightness to different viewing angles. Such a LCD device may differentiate itself among similar products, and achieve enhanced competitiveness in the market. The LCD device taught by the present invention includes the above described backlight module. The LCD device may differentiate itself among similar products, and achieve enhanced competitiveness in the market.

Above are embodiments of the present invention, which does not limit the scope of the present invention. Any equivalent amendments within the spirit and principles of the embodiment described above should be covered by the protected scope of the invention.

What is claimed is:

1. A light source module, comprising a substrate, a plurality of first light emitting diodes (LEDs) disposed on the substrate, and a plurality of second LEDs disposed on the substrate, wherein the first and second LEDs provide light of different viewing angles.

2. The light source module according to claim 1, wherein each first LED comprises a first reflection cup on the substrate, a first lighting chip in a first indentation of the first reflection cup, and a first phosphor filling the first indentation and covering the first lighting chip, where the first indentation is provided on a side of the first reflection cup away from the substrate; and
each second LED comprises a second reflection cup on the substrate, a second lighting chip in a second indentation on the second reflection cup, and a second phosphor filling the second indentation and covering the second lighting chip, where the second indentation is provided on a side of the second reflection cup away from the substrate; wherein the first and second indentations are of different shapes.

3. The light source module according to claim 2, wherein the first indentation has a bottom side and a slant side wall surrounding the bottom side forming a first included angle relative to the bottom side; the first lighting chip is disposed on the bottom side of the first indentation;
the second indentation has a bottom side and a slant side wall surrounding the bottom side forming a second included angle relative to the bottom side; the second lighting chip is disposed on the bottom side of the second indentation; and
the first and second included angles are different.

4. The light source module according to claim 3, wherein the first and second included angles are greater than 90 degrees.

5. The light source module according to claim 2, wherein the first and second lighting chips are LED lighting chips; and the LED chips are blue-light or white-light LED chips.

6. The light source module according to claim 5, wherein the first and second lighting chips are of a same color or of different colors.

7. The light source module according to claim 1, wherein the first and second LEDs are arranged into rows at uniform intervals on the substrate; and the first and second LEDs along each row are arranged alternately at uniform intervals.

8. The light source module according to claim 1, wherein the first and second LEDs are disposed to a same side of the substrate.

9. A backlight module, comprising a light source module as claimed in claim 1.

10. A liquid crystal display (LCD) device, comprising a light source module as claimed in claim 1.
